(19) United States
(12) Patent Application Publication
(10) Pub. No.: US 2016/0308873 A1
(43) Pub. Date: Oct. 20, 2016

(54) MULTI-OBJECT CONCURRENT CONTROL SYSTEM AND METHOD FOR CONCURRENT CONTROLLING MULTI-OBJECT

(71) Applicant: ELECTRONICS AND TELECOMMUNICATIONS RESEARCH INSTITUTE, Daejeon (KR)

(72) Inventor: Sung Kee NOH, Daejeon (KR)

(21) Appl. No.: 15/066,335

(22) Filed: Mar. 10, 2016

(30) Foreign Application Priority Data
Apr. 15, 2015 (KR) 10-2015-0053277

(51) Int. Cl. H04L 29/06; H04L 29/08

(52) U.S. Cl. CPC H04L 63/102; H04L 63/0876; H04L 67/42; H04L 67/1095

(57) ABSTRACT

A multi-object concurrent control method includes performing a user authentication received from a client apparatus and user apparatuses; in response to the user authentication being completed, creating a virtual personal space through an OPS (Orchestrated Personal Space) service at a request by the client apparatus; registering a shared resource received from the client apparatus in a media server; registering a plurality of user apparatuses in the virtual personal space by inviting, by the client apparatus, the plurality of user apparatuses to the virtual personal space; and controlling, by the client apparatus, an operation of executing the shared resource through a data session connection to the invited apparatuses.

### CROSS-REFERENCE TO RELATED APPLICATION

The present application claims priority to Korean patent application number 10-2015-0053277, filed on Apr. 15, 2015, the entire disclosure of which is incorporated herein in its entirety by reference.

### BACKGROUND

1. Field of Invention

Various embodiments of the present disclosure relate to an object control system, and more particularly, to a multi-object concurrent control system capable of virtualizing multi-objects located in numerous spaces as objects located in one physical space at a wanted time point and concurrently controlling the virtualized multi-objects, and a multi-object concurrent control method thereof.

2. Description of Related Art

A conventional virtual reality means an interface between a human and a computer that realizes a certain environment or a certain object as a virtual object expressed in a situation in a computer as if it interacts with the actual surrounding situation.

Such a conventional virtual reality has technical limitations in that it provides interactions between only a single virtual object and the actual object, and thus it is difficult to provide interactions between various actual objects located in various spaces.

### SUMMARY

Various embodiments of the present disclosure are directed to provide a multi-object concurrent control system capable of virtualizing multi-objects located in various spaces in one physical space at a wanted time point and concurrently controlling the multi-objects, and a multi-object concurrent control method thereof

According to an embodiment of the present disclosure, there is provided a multi-object concurrent control method including performing a user authentication received from a client apparatus and user apparatuses; in response to the user authentication being completed, creating a virtual personal space through an OPS (Orchestrated Personal Space) service at a request by the client apparatus; registering a shared resource received from the client apparatus in a media server; registering a plurality of user apparatuses in the virtual personal space by inviting, by the client apparatus, the plurality of user apparatuses to the virtual personal space; and controlling, by the client apparatus, an operation of executing the shared resource through a data session connection to the invited apparatuses.

In an embodiment, the multi-object concurrent control method may further include receiving status information on at least one of an on operation, off operation, and master apparatus by completion of the user authentication of the client apparatus, after the performing of a user authentication.

In an embodiment, the registering of a shared resource in the media server may include receiving a list of shared resources of the client apparatus at a synchronization request regarding the shared resource received from the client apparatus; receiving a list of shared resources stored in the media server at the synchronization request regarding the shared resource; comparing the list of shared resources of the client apparatus and the list shared resources of the media server, and marking in a list of shared resources for transmission to the media server; and transmitting the marked list of shared resources to the client apparatus in order to register the shared resource in the media server in the client apparatus.

In an embodiment, the registering of a shared resource in the media server may include requesting information on an accommodation capability for the shared resource to the media server; and receiving the information on an accommodation capability for the shared resource from the media server.

In an embodiment, the controlling of an operation of executing the shared resource may include receiving a request from the client apparatus to control an operation of executing the shared resource of the user apparatuses inside the virtual personal space; and broadcasting to the user apparatuses the request to control an operation of executing the shared resource.

In an embodiment, the request to control an operation of executing the shared resource may include an ID of the shared resource to be executed.

According to another embodiment of the present disclosure, there is provided a multi-object concurrent control system including a media server configured to store a shared resource, and to provide the shared resource at a request from a client apparatus or a plurality of user apparatuses; and a multi-object concurrent control server configured to invite the plurality of user apparatuses and create a virtual personal space through an OPS (Orchestrated Personal Space) service generated at a request by the client apparatus, and to control an operation of executing the shared resource of the user apparatuses invited to the virtual personal space based on shared resources registered in the media server.

In an embodiment, the multi-object concurrent control server may receive status information on at least one of an on operation, off operation, and master apparatus by completion of a user authentication of the client apparatus.

In an embodiment, the multi-object concurrent control server may compare a list of shared resources of the client apparatus received from the client apparatus and a list of shared resources of the media server received from the media server at a synchronization request regarding the shared resource received from the client apparatus, mark in a list of shared resources for transmission to the media server, and transmit the marked list of shared resources to the client apparatus.

In an embodiment, in response to receiving a request from the client apparatus to control an operation of executing the shared resource of the user apparatuses inside the virtual personal space, the request to control an operation of executing the shared resource may be broadcasted to the user apparatuses.

In an embodiment, in response to receiving a request to transmit the shared resource from the user apparatuses, the media server may transmit the shared resource through a data session set with the user apparatuses.

A multi-object concurrent control system of the present disclosure is capable of virtually objectifying and managing various actual objects located in various spaces in a virtual space, and of managing the virtual objects in the virtual space as if they actually exist in a virtual personal space, thereby concurrently controlling the multi-objects located in various spaces at a desired time point regarding that they are located in one physical space.

### BRIEF DESCRIPTION OF THE DRAWINGS

The above and other features and advantages of the present disclosure will become more apparent to those of ordinary skill in the art by describing in detail embodiments with reference to the attached drawings in which:

FIG. 1 is a view illustrating a multi-object concurrent control system according to an embodiment of the present disclosure;

FIG. 2 is a signal flowchart illustrating an example of an operation of creating an OPS (Orchestrated Personal Space) service and transmitting status information according to an embodiment of the present disclosure;

FIG. 3 is a signal flowchart illustrating an example of an operation of synchronizing jointly controlled resources according to an embodiment of the present disclosure; and

FIG. 4 is a signal flowchart illustrating a client apparatus concurrently controlling a user apparatus according to an embodiment of the present disclosure.

### DETAILED DESCRIPTION

Hereinafter, embodiments will be described in greater detail with reference to the accompanying drawings. Embodiments are described herein with reference to cross-sectional illustrates that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘first’ and ‘second’ may be used to describe various components, but they should not limit the various components. Those terms are only used for the purpose of differentiating a component from other components. For example, a first component may be referred to as a second component, and a second component may be referred to as a first component and so forth without departing from the spirit and scope of the present invention. Furthermore, ‘and/or’ may include any one of or a combination of the components mentioned.

Furthermore, ‘connected’ represents that one component is directly connected to another component or indirectly connected through another component.

In this specification, a singular form may include a plural form as long as it is not specifically mentioned in a sentence. Furthermore, ‘include/comprise’ or ‘including/comprising’ used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

The present disclosure provides a multi-object concurrent control system where an actual object is virtually objectified and managed as a virtual object in a virtual logic space defined as a smart space, and a user creates a virtual personal space using the virtual objects being managed so as to concurrently control the virtual objects in the virtual personal space, and a multi-object concurrent control method thereof.

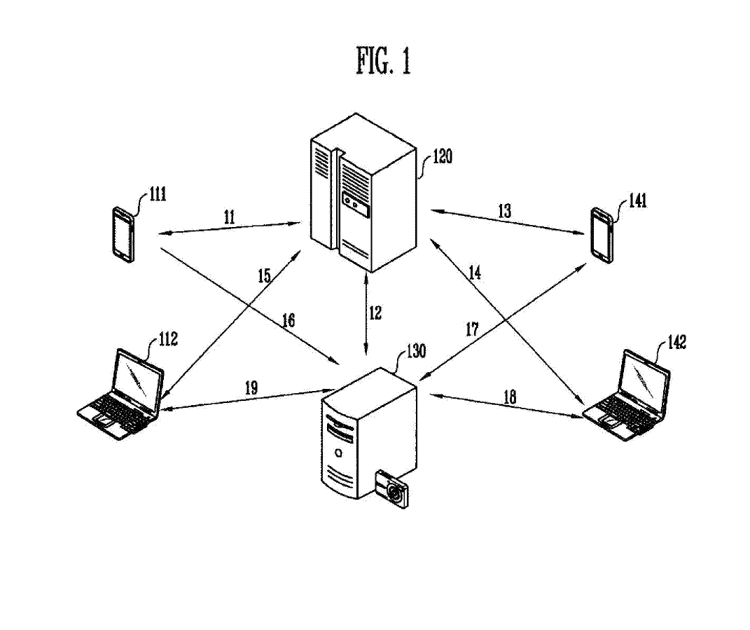

FIG. 1 is a view illustrating an example of a multi-object concurrent control system according to an embodiment of the present disclosure.

Referring to FIG. 1, the multi-object concurrent control system includes a plurality of user apparatuses 111, 112, 141, 142, a multi-object concurrent control server 120, and a media server 130.

The plurality of user apparatuses 111, 112, 141, 142 are user apparatuses that store or utilize resources. A first user apparatus 111 and a third user apparatus 141 may be smart phones, and a second user apparatus 112 and a fourth user apparatus 142 may be smart tablets.

Hereinafter, of the plurality of user apparatuses 111, 112, 141, 142, the first user apparatus 111 will be regarded as a client apparatus, for example. Herein, the client apparatus is an apparatus that directly controls the plurality of user apparatuses 112, 141, 142. Therefore, the plurality of user apparatuses 112, 141, 142 may be controlled by a certain client apparatus 111, and may be shared by other user apparatuses.

The multi-object concurrent control server 120 is connected 11, 13, 14, 15 to the plurality of user apparatuses 111, 112, 141, 142, and is also connected 12 to the media server 130.

At a request by the client apparatus 111, the multi-object concurrent control server 120 invites the plurality of user apparatuses 112, 141, 142 and creates a virtual personal space through an OPS (Orchestrated Personal Space) service. Herein, since the multi-object concurrent control server 120 provides the OPS service, it may be called an OPS server.

At a request by the client apparatus 111, based on the shared resources registered in the media server 130, the multi-object concurrent control server 120 controls an operation of executing a shared resource of the apparatuses 112, 141, 142 invited to the virtual personal space.

The media server 130 is a server that stores various media data including images and videos. Herein, the media server 130 may upload a shared resource from the client apparatus 111 in order to provide the OPS (Orchestrated Personal Space) service, and may transmit the shared resource through data sessions 17, 18, 19 connected by the user apparatuses 112, 141, 142 to share with.

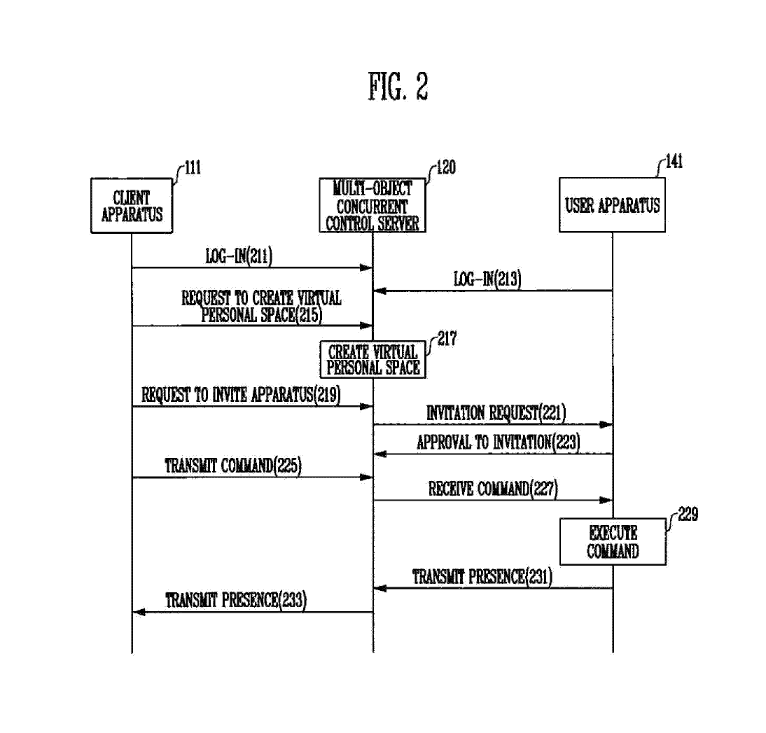

FIG. 2 is a signal flowchart illustrating an example of an operation of creating an OPS (Orchestrated Personal Space) service and transmitting status information according to an embodiment of the present disclosure.

Hereinafter, explanation will be made mainly on the client apparatus 111, multi-object concurrent control server 120, and user apparatus 141, with reference to FIG. 2.

The client apparatus 111 performs a user authentication to the multi-object concurrent control server 120 (step 211). Herein, the user authentication may be performed for example in a log-in method, and the log-in may be performed by inputting an ID and password information from the client apparatus 111.

The user apparatus 141 performs a user authentication to the multi-object concurrent control server 120 (step 213). Herein, the user authentication may be performed in the log-in method as well.

By doing this, the client apparatus 111 and the user apparatus 141 may be connected to the multi-object concurrent control server 120 and perform data transceiving. Furthermore, through the log-in of the client apparatus 111 and the user apparatus 141, the multi-object concurrent control server 120 checks status information (on, off, master and the like) being transmitted from the client apparatus 111, and prepares to process a control command of a user owned apparatus (for example, head mounted display (hmd), smart phone, smart tablet).

The client apparatus 111 requests creation of a virtual personal space of the OPS (Orchestrated Personal Space) service (step 215). The virtual personal space is a space where the OPS service may be provided, and the client apparatus 111 requests that it is possible to perform a joint operation with another client apparatus or user apparatus that it invited.

The multi-object concurrent control server 120 creates the virtual personal space, i.e. a room through the OPS service (step 217).

Thereafter, the client apparatus 111 requests the multi-object concurrent control server 120 to invite an apparatus (step 219).

At the request by the client apparatus 111 to invite an apparatus, the multi-object concurrent control server 120 sends an invitation to the corresponding user apparatus 141 (step 221).

If the user apparatus 141 approves the invitation, the user apparatus 141 transmits an invitation approval to the multi-object concurrent control server 120 (step 223).

The client apparatus 111 transmits a command to control invited apparatuses to the multi-object concurrent control server 120 (step 225).

The multi-object concurrent control server 120 transmits the command from the client apparatus 111 to a user apparatus 141 corresponding to the command (step 227).

The user apparatus 141 executes the command from the client apparatus 111 (step 229).

The user apparatus 141 transmits a presence according to the execution of the command to the multi-object concurrent control server 120 (step 231).

The multi-object concurrent control server 120 transmits the presence according to the execution of the command of the user apparatus 141 to the client apparatus 111 (step 233).

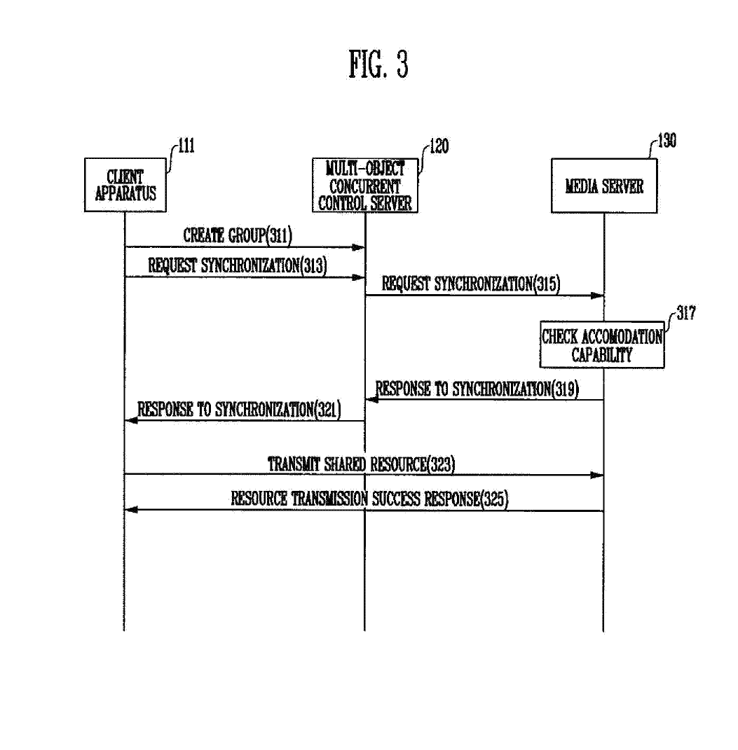

FIG. 3 is a signal flowchart illustrating an example of an operation of synchronizing a jointly controlled resource according to an embodiment of the present disclosure.

Hereinafter, explanation will be made mainly on the client apparatus 111, multi-object concurrent control server 120, and media server 130 with reference to FIG. 3.

The client apparatus 111 requests the multi-object concurrent control server 120 to create a group (step 311).

The client apparatus 111 requests a synchronization to the multi-object concurrent control server 120 in order to request a resource accommodation capability of the media server 130 (step 313). For the synchronization request, the client apparatus 111 transmits a list of data of shared resources that it has.

The multi-object concurrent control server 120 transmits the synchronization request of the client apparatus 111 to the media server 130 (step 315). Herein, the synchronization request includes a request to check the accommodation capability of the media server 130.

The media server 130 checks its accommodation capability according to the synchronization request from the client apparatus 111 (step 317).

The media server 130 transmits the accommodation capability for the resource that it has to the multi-object concurrent control server 120 in a response to the synchronization request (step 319). Herein, the media server 130 may transmit a file list stored therein to the multi-object concurrent control server 120.

Upon receiving the response to the synchronization request from the media server 130, the multi-object concurrent control server 120 compares the list of resources of the client apparatus 111 and the list of resources stored in the media server 130, and marks in a list of necessary resources.

The multi-object concurrent control server 120 transmits a response to the synchronization based on the marked list of resources to the client apparatus 111 (step 321).

Upon receiving the response to the synchronization, the client apparatus 111 transmits a shared resource to the media server 130 (step 323).

When transmitting the shared resource is completed, the media server 130 transmits a resource transmission success response to the client apparatus 111 (step 325).

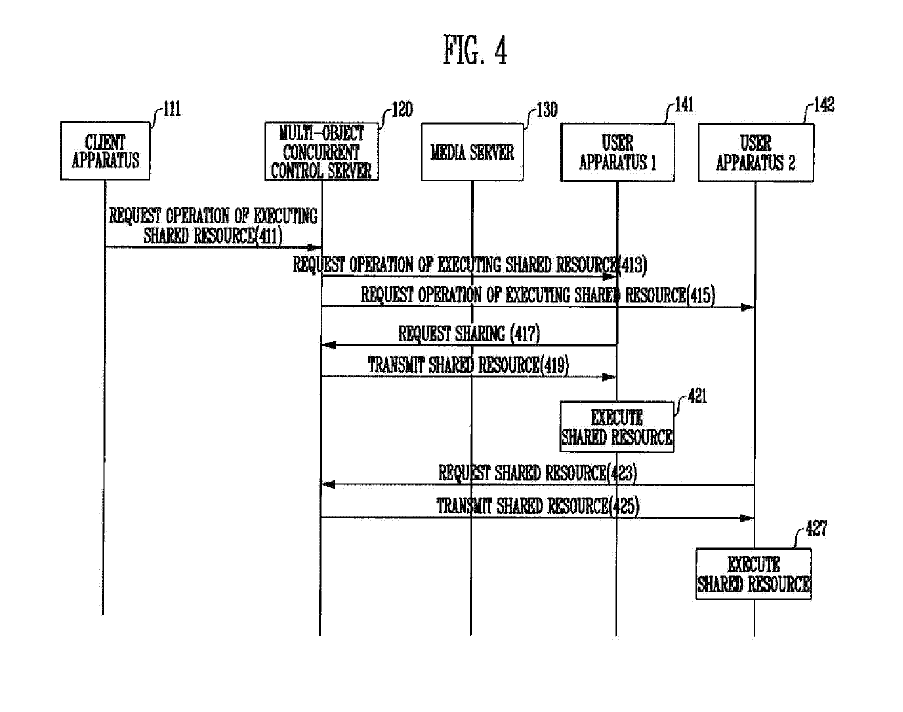

FIG. 4 is a signal flowchart illustrating an operation of a client apparatus concurrently controlling a user apparatus according to an embodiment of the present disclosure.

Hereinafter, explanation will be made mainly on the client apparatus 111, multi-object concurrent control server 120, first user apparatus 141, and second user apparatus 142, with reference to FIG. 4.

The client apparatus 111 requests the multi-object concurrent control server 120 to execute a shared resource of the user apparatuses 141, 142 (step 411).

The multi-object concurrent control server 120 transmits the request to execute a shared resource received from the client apparatus 111 to each of the user apparatuses 141, 142 (step 413, step 415). For this purpose, the multi-object concurrent control server 120 transmits the corresponding operation of executing the shared resource and an ID of the resource to all the user apparatuses 141, 142 participating in the current service through a broadcasting message. The ID of the resource is for the user apparatuses 141 142 to obtain the resource that is subject to the corresponding operation from the media server 130.

Upon receiving the request to execute a shared resource, the first user apparatus 141 requests the shared resource to the media server 130 based on the received ID of the resource (step 417).

The media server 130 transmits the shared resource requested by the first user apparatus 141 to the first user apparatus 141 (step 419).

Upon receiving the shared resource, the first user apparatus 141 performs an operation of executing the shared resource (step 421).

Upon receiving the request to execute a shared resource, the second user apparatus 142 requests the shared resource to the media server 130 based on the received ID of the resource (step 423).

The media server 130 transmits the shared resource requested by the second user apparatus 142 to the second user apparatus 142 (step 425).

Upon receiving the shared resource, the second user apparatus 142 performs an operation of executing the shared resource (step 427).

The first user apparatus 141 and the second user apparatus 142 may be provided with the resource through a data session with the media server 130.

For example, when a request to execute viewing of a file is transmitted from the client apparatus 111 to the multi-object concurrent control server 120 in order to view a photo through a gallery app, the user apparatuses 141, 142 may perform the same operation of executing viewing of the file.

As aforementioned, through the multi-object concurrent control server 120 proposed in the present disclosure, an actual object may be virtually objectified and managed as a virtual object in a virtual logic space defined as a smart space, the user creating a virtual personal space using the virtual objects, and concurrently outputting and controlling the virtual objects.

According to the present disclosure, the client apparatus and user apparatuses not only enables the user to concurrently control and output a shared object and resource, but also enables numerous users to share the control right, thereby improving the efficiency of shared operation.

In the drawings and specification, there have been disclosed typical exemplary embodiments of the invention, and although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A multi-object concurrent control method comprising:
performing a user authentication received from a client apparatus and user apparatuses;
creating, if the user authentication being completed, a virtual personal space through an OPS (Orchestrated Personal Space) service at a request by the client apparatus;
registering a shared resource received from the client apparatus in a media server;
registering the user apparatuses in the virtual personal space; and
controlling an operation of executing the shared resource through a data session connection to the registered user apparatuses.

2. The method according to claim 1, further comprising:
receiving status information on at least one of an on operation, off operation, and master apparatus by completion of the user authentication of the client apparatus, after the performing of a user authentication.

3. The method according to claim 1, wherein the registering of a shared resource in the media server comprises:
receiving a list of shared resources of the client apparatus at a synchronization request regarding the shared resource received from the client apparatus;
receiving a list of shared resources stored in the media server at the synchronization request regarding the shared resource;
comparing the list of shared resources of the client apparatus and the list shared resources of the media server, and marking in a list of shared resources for transmission to the media server; and
transmitting the marked list of shared resources to the client apparatus in order to register the shared resource in the media server in the client apparatus.

4. The method according to claim 1, wherein the registering of a shared resource in the media server comprises:
requesting information on an accommodation capability for the shared resource to the media server; and
receiving the information on an accommodation capability for the shared resource from the media server.

5. The method according to claim 1, wherein the controlling of an operation of executing the shared resource comprises:
receiving a request from the client apparatus to control an operation of executing the shared resource of the user apparatuses inside the virtual personal space; and
broadcasting to the user apparatuses the request to control an operation of executing the shared resource.

6. The method according to claim 1, wherein the request to control an operation of executing the shared resource comprises an ID of the shared resource to be executed.

7. A multi-object concurrent control system comprising:
a media server configured to store a shared resource, and to provide the shared resource at a request from a client apparatus or a plurality of user apparatuses; and
a multi-object concurrent control server configured to invite the plurality of user apparatuses and create a virtual personal space through an UPS (Orchestrated Personal Space) service generated at a request by the client apparatus, and to control an operation of executing the shared resource of the user apparatuses invited to the virtual personal space based on shared resources registered in the media server.

8. The system according to claim 7, wherein the multi-object concurrent control server receives status information on at least one of an on operation, off operation, and master apparatus by completion of a user authentication of the client apparatus.

9. The system according to claim 7, wherein the multi-object concurrent control server compares a list of shared resources of the client apparatus received from the client apparatus and a list of shared resources of the media server received from the media server at a synchronization request regarding the shared resource received from the client apparatus, marks in a list of shared resources for transmission to the media server, and transmits the marked list of shared resources to the client apparatus.

10. The system according to claim 7, wherein, in response to receiving a request from the client apparatus to control an operation of executing the shared resource of the user apparatuses inside the virtual personal space, the request to control an operation of executing the shared resource is broadcasted to the user apparatuses.

11. The system according to claim 7, wherein, in response to receiving a request to transmit the shared resource from the user apparatuses, the media server transmits the shared resource through a data session set with the user apparatuses.
